(19) United States
(12) Patent Application Publication
(10) Pub. No.: US 2020/0408333 A1
(43) Pub. Date: Dec. 31, 2020

(54) J-HOOK CABLE SUPPORT DEVICE

(71) Applicant: Cablofil, Inc., Mascoutah, IL (US)

(72) Inventor: Dallas KELLERMAN, Belleville, IL (US)

(21) Appl. No.: 16/454,796

(22) Filed: Jun. 27, 2019

(51) Int. Cl. F16L 3/10; F16L 3/22

(52) U.S. Cl. CPC F16L 3/1058; F16L 3/221

(57) ABSTRACT

A J-Hook cable support contains a cable-receiving saddle having two ends, with a stem and a tip extending from each end of the saddle. The saddle and the area between the two ends of the saddle form a cable-receiving area. The cable support includes a wire retainer, which is capable of sliding through an opening in the tip of the cable support. By sliding the wire retainer through the slot, the end user may selectively open and close the cable-receiving area. The J-Hook cable support can be part of an assembly comprising one or a plurality of cable supports and a mounting member. The mounting member comprises a vertical member and a horizontal member. The cable supports are fastened to the vertical member. The horizontal member extends at an angle from a distal end of the vertical member and may be used to fasten the mounting member to a structural support.

### FIELD OF THE DISCLOSURE

The present disclosure generally relates to a J-Hook cable support that can be used for organizing, bending, and supporting cable.

### BACKGROUND

Cable installation requires bending, redirecting, and otherwise organizing cable. Excess bending or flexing of a cable may cause damage to the cable. End users must be careful not to bend the cable in excess of the particular cable's minimum bending radius. The J-Hook cable support with varying curvature and a wire retainer allows an end user to bend cable at an appropriate radius as well as to selectively contain a cable-receiving area to minimize movement of one or more cables.

### SUMMARY OF THE DISCLOSURE

Among the various aspects of the present disclosure is the provision of a J-Hook cable support that has a cable-receiving area capable of being in an open or closed position. The cable support is usable for supporting and redirecting cable without excessive bending or constricting of the cable. The end user may selectively open and close the cable-receiving area.

In one aspect, the J-Hook cable support contains a cable-receiving saddle having two ends, with a stem and a tip extending from each end of the saddle. The cable-receiving saddle and the area between the two ends of the saddle form a cable-receiving area. The cable support includes a wire retainer, which is capable of sliding through an opening in the tip of the cable support. By sliding the wire retainer through the slot, the end user may selectively open and close the cable-receiving area. The wire retainer as disclosed in this invention may be manipulated into the closed position by both sliding and rotating. Allowing both sliding and rotating gives the end user more options for setting the closed position. With more options, the end user is less likely to be limited by obstructions or other potential constraints on location and functionality.

In another aspect, the J-Hook cable support is part of an assembly comprising one or a plurality of cable supports and a mounting member. The mounting member comprises a vertical member and a horizontal member. The cable supports are fastened to the vertical member. The horizontal member extends at an angle from a distal end of the vertical member and may be used to fasten the mounting member to a stud or other structural support.

### BRIEF DESCRIPTION OF THE DRAWINGS

FIG. 1 is a front perspective view of the J-Hook cable support in a closed position.

FIG. 2 is a front perspective view of the J-Hook cable support in an open position.

FIG. 3 is a rear perspective of the J-Hook cable support of FIG. 1.

FIG. 4 is a perspective view of another embodiment of a cable support of the present invention in which two cable supports of the type shown in FIG. 1 are fastened to a mounting assembly.

FIG. 5 is a perspective view of FIG. 4 in which the cable supports are fastened to the mounting assembly.

### DETAILED DESCRIPTION

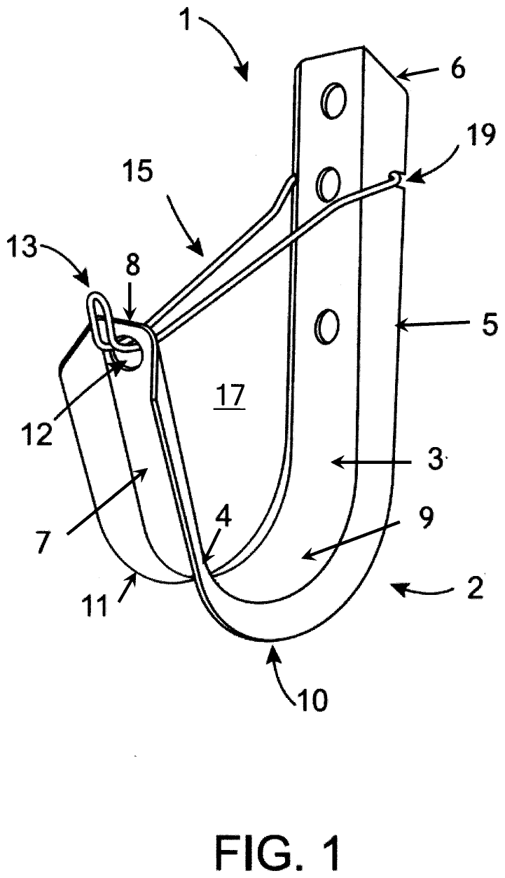

Referring generally to FIGS. 1-3, a J-Hook cable support for organizing, bending, and supporting cable is generally indicated at reference numeral 1. In the illustrated embodiment, the cable support 1 is a unitary, one-piece construction. The cable support 1 may be formed from a single sheet metal (e.g., steel or aluminum) or other suitable material (e.g., plastic). In one embodiment, the cable support 1 is formed from galvanized steel. The cable support 1 can be molded, die-cast, or otherwise suitably formed.

It is understood that the cable support 1 can be used with other cable supports or devices within the scope of the invention. The orientation of the cable support 1 in the drawings provides the point of reference for the terms defining relative locations and positions of structures and components, including but not limited to the terms “upper,” “lower,” “left,” “right,” “top,” “bottom,” “distal,” “forward,” and “rearward,” as used throughout the present disclosure, and are intended for convenience of description, not to limit an invention disclosed herein or its components to any one positional or spatial orientation.

The cable support 1 comprises a curved saddle region 2. The curved saddle region 2 has a width and a length. In one embodiment, the length of the saddle region 2 exceeds the width of the saddle region 2. In another embodiment, the width of the saddle region 2 exceeds the length of the saddle region 2. In yet another embodiment, both the width and length of the saddle region 2 are equal.

Saddle region 2 has a first end 3 and a second end 4. An elongated stem 5 transitions or emerges upwardly from the first end 3 of the saddle region 2. The elongated stem 5 has a width and a length. In one embodiment, the length can exceed the width of the stem 5. In another embodiment, the width can exceed the length of the stem 5, or the width and length of the stem 5 can be equal. The cable support 1 terminates at a first distal end 6 at the end of the stem 5.

The cable support 1 further includes a tip 7 that extends from the second end 4 of the saddle region 2 that is opposite of the first end 5. In one embodiment, tip 7 curves upwardly from the saddle region 2. In another embodiment, the tip 7 curves upwardly and outwardly from the saddle region 2. In yet another embodiment, the tip 7 curves upwardly and inwardly from the saddle region 2. The cable support 1 terminates at a second distal end 8 at the end of the tip 7.

In the illustrated embodiment, the J-Hook cable support 1 is a unitary, one-piece construction. In other embodiments, the saddle 2, stem 5, and tip portion 7 may each be separate constructions, including where the saddle 2 and stem 5 are a unitary, one-piece construction separate from the tip 7 and where the saddle 2 and tip 7 are a unitary, one-piece construction separate from the stem 5. J-Hook cable support 1 may have various curvatures and shapes. Different curvatures and shapes may be used to meet the minimum bending radius of different cables. In the illustrated embodiment, J-Hook cable support 1 has a unitary width. In other embodiments, J-Hook cable support 1 may have varying widths.

For example, in some embodiments, the J-Hook cable support 1 comprises a central portion 9 and distal flanges 10 and 11. The central portion 9 may vary in width. For example, to accomplish a certain minimum bending radii, the central portion 9 at the location of the saddle 2 may be wider or narrower than at the location of stem 5 or tip 7. In some embodiments, the central portion is relatively flat, while in other embodiments, the central portion is concave or convex. In yet other embodiments, the central portion forms a v-shaped valley, which can be configured to be wide or more narrow.

The distal flanges 10 and 11 extend downwardly from either side of the flat central portion 9. For example, the distal flanges 10 and 11 can extend downwardly at an angle between 0 and 90 degrees from the tangent plane of the central portion 9. Distal flanges 10 and 11 may constitute a planar surface or a curved surface. In the illustrated embodiment, distal flanges 10 and 11 span the entire length of the J-Hook. In other embodiments, distal flanges 10 and 11 may span only a portion of J-Hook cable support 1.

Tip 7 includes an opening 12 at the second distal end 8 of the cable support 1. The opening 12 is an opening that has a width and a height. The width of the opening 12 is less than the width of the tip 7. In some embodiments, the width of the opening 12 is greater than the height of the opening 12, such that the opening is oriented such as to be perpendicular to the direction that tip 7 extends from the saddle 2. In some embodiments, the width of the opening 12 is substantially similar to the diameter of a wire retainer 15, described in greater detail, below.

Stem 5 comprises at least one fastener holes 16. Fastener holes 16 may be used with screws, rivets, nails, or other securing devices for the purpose of fastening J-Hook cable support 1 to a surface. In some embodiments, stem 5 comprises a thread impression (not shown) which allows for optional offsets when used on trees. In other embodiments, the thread impression offers other mounting options, for example, ones that require fewer fasteners.

In some embodiments, stem 5 contains two or more notches 19 that can be located along the side edges, or flanges 10 and 11, of stem 5. For example, in one embodiment, notches 19 are located in flanges 10 and 11 proximate to the first distal end 6 of the cable support 1. In some embodiments, the width of the notches 19 is substantially similar to the diameter of the wire retainer 15.

Wire retainer 15 comprises a u-shaped portion 21 and two legs 22 and 23 extending from the u-shaped portion 21. In some embodiments, the u-shaped portion 21 can be bent substantially perpendicular to a plane which contains both legs 22 and 23. In certain embodiments, the wire retainer 15 is moveably engaged through opening 12, such that the u-shaped portion 21 is configured to moveably abut tip 7 and u-shaped portion 21 prevents wire retainer 15 from fully passing through opening 12 towards the stem 5. The distal end of leg 22 has a bent end 24. The distal end of leg 23 has a bent end 25. Bent ends 24 and 25 are configured so as to bend inwardly towards each other. In some embodiments, the bent ends are capable of passing through notches 19. The length of each leg 22 and 23 is substantially similar to the distance between opening 12 and notches 19. In some embodiments, wire retainer 15 is composed of at least one of brass, steel, copper, plastic and aluminum, however, any different material may be used for wire retainer 15.

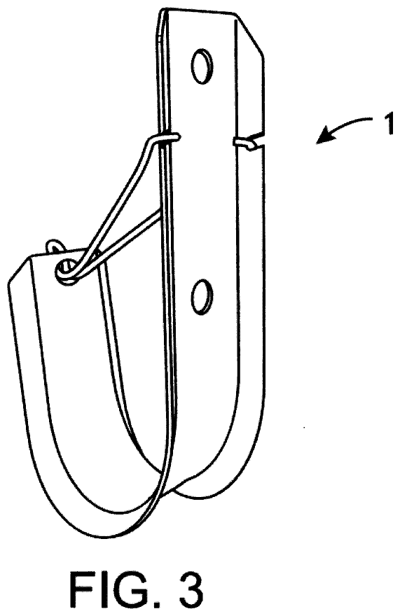

In some embodiments, wire retainer 15 is capable of sliding through opening 12 and bent ends 24 and 25 are capable of passing through notches 19. For example, as illustrated in FIG. 3, the end user of the J-Hook cable support 1 may slide the wire retainer 15 to a closed position, such that the bent ends 24 and 25 removeably pass through notches 19 and fasten therebehind. In the closed position, the u-shaped portion 21 passes through the opening 12, abuts the tip 7 on the side opposite a cable-receiving area 17, and the bent ends 24 and 25 removeably fasten behind notches 19. The closed position is shown in FIG. 1.

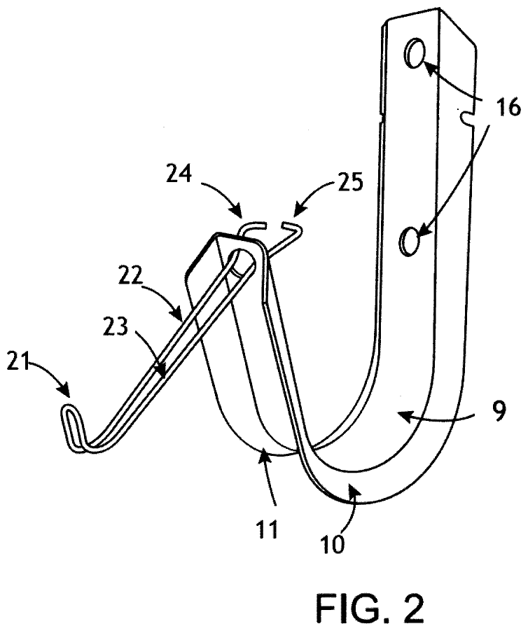

The end user also has the option of removing the bent ends 24 and 25 from the notches 19 to position the wire retainer 15 in an open position. An example of an open position is shown in FIG. 2. An open position is any position of the wire retainer 15 other than the closed position. Effectively, by putting the wire retainer 15 in the closed position, the end user may close off or contain the cable-receiving area 17 so as to limit cable movement around the J-Hook cable support 1. The open position may be used to add or remove cables.

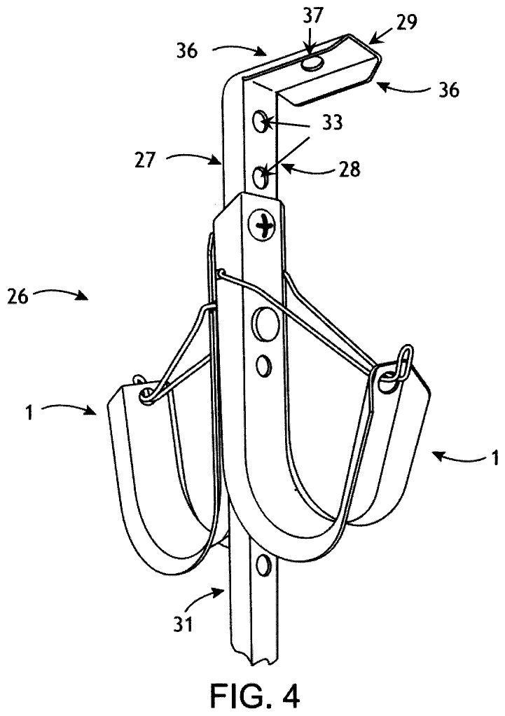

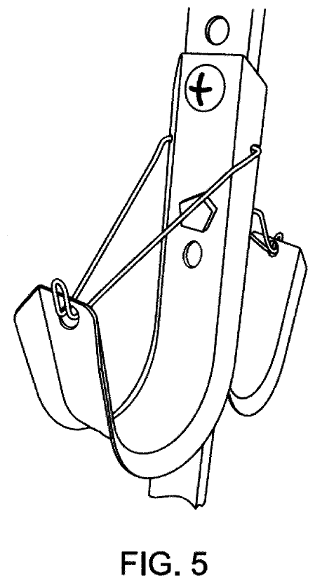

FIGS. 4-5 illustrate an assembly 26 for mounting one or more J-Hook cable supports 1 to facilitate cable management. Assembly 26 comprises a mounting member 27 and one or more J-Hook cable supports 1. Mounting member 27 further comprises a vertical member 28 and a horizontal member 29. Vertical member 28 and horizontal member 29 may be a unitary, one-piece construction or may be two separate pieces.

The assembly 26 may be formed from a single sheet metal (e.g., steel, brass, copper or aluminum) or other suitable material (e.g., plastic). In one embodiment, the assembly 26 is formed from galvanized steel. The assembly 26 can be molded, die-cast, or otherwise suitably formed. In the illustrated embodiment, the assembly 26 is a unitary, one-piece construction. In other embodiments, assembly 26, mounting member 27, vertical member 28, and horizontal member 29 may each be separate constructions or portions of each may comprise a unitary, one-piece construction.

In some embodiments, vertical member 28 has a similar width as J-Hook cable support 1. In the illustrated embodiment, vertical member 28 contains a flat central portion 30 and flanges 31 and 32 (not shown). In another embodiment, vertical member 28 does not have any flanges. In some embodiments, flanges 31 and 32 have substantially the same width as flanges 10 and 11, such that cable support can fasten snugly against assembly 26.

In many embodiments, mounting member 27 can also have extruded holes that allow the cable support 1 to be located at different planes. Such configurations potentially reduce the amount of hardware needed. In some embodiments, flanges 31 and 32 can also be configured to have an opening which allows bent ends 24 and 25 to pass through. Such configurations may be used to add extra strength to assembly 26.

In some embodiments, vertical member 28 has one or more fastener holes 33. In some embodiments, the fastener holes 33 are spaced substantially the same distance apart as fastener holes 16. In some embodiments, fastener holes 33 have substantially the same diameter as fastener holes 16. An end user may align fastener holes 33 with fastener holes 16 and, by use of screws, nails, or rivets, attach the J-Hook cable support 1 to vertical member 28. Fastener holes 33 may be used to attach a plurality of J-Hook cable supports 1 to vertical member 28.

Horizontal member 29 extends from a distal end of vertical member 28. Together the plane of horizontal member 29 and the plane of vertical member 28 form an angle between 0 and 180 degrees. In some embodiments, horizontal member 29 has substantially the same width at vertical member 28, while in other embodiments, horizontal member 29 has a width that differs from that of vertical member 28. In some embodiments, horizontal member 29 contains a flat central portion 34 and flanges 35 and 36, while in other embodiments, horizontal member 29 does not contain flanges 35 and 36. In certain embodiments, horizontal member 29 contains one or more fastener holes 37. Fastener holes 37 may be used in conjunction with screws, nails, or rivets for the purpose to attaching assembly 26 to a surface, such as a wooden stud.

In some embodiments, when a J-hook cable support 1 is fastened to an assembly 26, bent ends 24 and 25 are configured to removeably fasten through notches 19 to assembly 26.

The cable support 1 as described above is versatile and permits a user to organize, bend, and/or support cables at any desired location or position.

Having described embodiments of the invention in detail, it will be apparent that modifications and variations are possible without departing from the scope of the invention defined in the appended claims.

When introducing elements of the illustrated embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A cable support comprising:
a cable-receiving saddle having a varying width, a first end and a second end opposite the first end;
a stem emerging from the first end of the saddle and terminating in a first distal end portion;
a tip emerging from the second end of the saddle and terminating in a second distal end portion;
an opening located in the distal end portion of the tip; and
a wire retainer passing through the opening and having an open position for loading a cable onto the cable-receiving saddle and a closed position to selectively contain a cable-receiving area of the cable support that is located above the saddle and between the tip and stem, the wire retainer comprising a u-shaped portion and a pair of legs emerging from each end of the u-shaped portion and terminating in distal ends, the distal ends of each leg bending inwardly toward the other leg.

2. The cable support of claim 1, wherein the u-shaped portion of the wire retainer comprises a bend substantially perpendicular to a plane containing the legs of the wire retainer, the bend in the wire retainer capable of holding the wire retainer within the opening when the wire retainer is in the closed position.

3. The cable support of claim 1, wherein when the wire retainer is in the open position, the legs of the wire retainer may slide within the opening and away from the stem to permit loading of cable onto the cable-receiving saddle.

4. The cable support of claim 1, wherein when the wire retainer is in the closed position, the distant ends of each leg pass around the distal end of the stem to secure the cable within the cable-receiving area.

5. The cable support of claim 1 wherein the distal end portion of the stem comprises a pair of notches on opposing sides of the distal end portion of the stem for retaining the bent distal ends of the wire retainer when the wire retainer is in the closed position.

6. The cable support of claim 1, wherein the widest width of the saddle is wider than the widest width of the slot.

7. The cable support of claim 1, wherein the J-Hook cable support has a central portion and flanges at either side of the central portion.

8. The cable support of claim 7, wherein the central portion varies in width.

9. The cable support of claim 7, wherein the flanges extend from the central portion of the J-Hook cable support at an angle between 0 and 90 degrees.

10. The cable support of claim 9, wherein the flanges are curved in shape.

11. The cable support of claim 1, wherein the distal end portion of the stem comprises fastener holes for use with at least one of screws, rivets, and nails.

12. The cable support of claim 1, wherein the tip of the saddle is oriented such that the planes occupied by the tip and the stem form an angle between 0 and 90 degrees.

13. The cable support of claim 1, wherein the cable support is composed of at least one of brass, steel, copper, and aluminum.

14. The cable support of claim 1, wherein the wire retainer may be removed by the end user.

15. The cable support of claim 1, wherein the wire retainer provides structural support for the cable support.

16. An assembly for supporting cable comprising:
a. a first and second cable support attached to a mounting member, the mounting member comprising a vertical member and a horizontal member.
b. each cable support comprising a cable-receiving saddle having a varying width, a first end and a second end opposite the first end;
c. a stem emerging from the first end of the saddle and terminating in a distal end portion;
d. a tip emerging from the second end of the saddle and terminating in a distal end portion;
e. an opening located in the distal end portion of the tip; and
f. a wire retainer passing through the opening and having at least an open position for loading a cable onto the cable-receiving saddle and a closed position to selectively contain a cable-receiving area of the cable support that is above the saddle and between the tip and stem, the wire retainer comprising a u-shaped portion and a pair of legs emerging from each end of the u-shaped portion and terminating in distal ends, the distal ends of each leg bending inwardly toward the other leg;
g. wherein the u-shaped portion of the wire retainer comprises a bend substantially perpendicular to a plane containing the legs of the wire retainer, the bend in the wire retainer capable of holding the wire retainer within the opening when the wire retainer is in the closed position;
h. wherein when the wire retainer is in the open position, the legs of the wire retainer may slide within the opening and away from the stem to permit loading of cable onto the cable-receiving saddle; and
i. wherein when the wire retainer is in the closed position, the distant ends of each leg pass around the distal end of the stem to secure the cable within the cable-receiving area.

17. The assembly of claim 16, wherein the cable supports are removable by the end user.

18. The assembly of claim 16, the u-shaped portion of the wire retainer comprises a bend substantially perpendicular to a plane containing the legs of the wire retainer, the bend in the wire retainer capable of holding the wire retainer within the opening when the wire retainer is in the closed position;

19. The assembly of claim 16, wherein the wire retainer is removable by the end user.

20. The assembly of claim 16, wherein when the wire retainer is in the closed position, the distant ends of each leg pass around the distal end of the stem to secure the cable within the cable-receiving area.

21. The assembly of claim 16, wherein when the wire retainer is in the open position, the legs of the wire retainer may slide within the opening and away from the stem to permit loading of cable onto the cable-receiving area.

22. The assembly of claim 16, wherein the horizontal member comprises a bend at an angle between 0 and 90 degrees relative to the plane of the horizontal member.

23. The assembly of claim 16, wherein the horizontal member is capable of pivoting relative to the vertical member.

24. The assembly of claim 16, wherein the cable supports are fastened to opposite sides of the vertical member.

25. The assembly of claim 16, wherein the cable supports are fastened to the same side of the vertical member.

26. The assembly of claim 16, wherein more than two cable supports may be attached to the vertical member.

27. The assembly of claim 16, wherein the vertical member contains at least two fastener holes allowing the end user to select the location of the cable support.

28. The assembly of claim 27, wherein the location of the fastener holes on the vertical member are spaced substantially the same distance apart as are the fastener holes on the stem of the cable support.

29. The assembly of claim 27, wherein the distal end portion of the stem comprises a combination of fastener holes for use with screws, rivets, or nails.

30. The assembly of claim 27, wherein more than one fastener hole is used to attach the cable support to the vertical member.

31. The assembly of claim 27, wherein different types of fasteners are used in combination to attach the cable support to the vertical member.
